(19) United States
(12) Patent Application Publication
(10) Pub. No.: US 2009/0121863 A1
(43) Pub. Date: May 14, 2009

(54) Medical safety monitor system

(76) Inventor: Rich Prior, Lancaster, CA (US)

Correspondence Address: Rich Prior, 4379 Paddock Way, Lancaster, CA, 93536, US

(21) Appl. No.: 11/985,203

(22) Filed: Nov. 13, 2007

(51) Int. Cl. G08B 1/08

(52) U.S. Cl. 340/539.12

(57) ABSTRACT

A medical alert system is presented. The system includes a remote control unit wearable by an individual. A motion sensor outputs a signal indicative of motion of the individual where an absence of signal indicates a potential need for medical assistance. A low power circuitry processes the signal to determine the absence of signal. The circuitry outputs a first signal after a first period of time when the absence of signal has been detected and a second signal after a second period of time when the absence of signal has been detected. A transmitter is responsive to the first and second signal transmits an alert signal indicating need for the medical assistance. The alert signal is repeated at intervals of the first period of time. An alert signal receiver module is configured to receive the transmitted alert signal and notify proper authorities of a medical or situation.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to alert systems and, more specifically, to a wearable remote control alert activator that is able to monitor lack of movement of a subject and contact a central station upon detecting an emergency situation.

### BACKGROUND OF THE INVENTION

Many currently known medical alert devices, akin to the “Life Alert” medical response pendant or wristband, enable at risk individuals live with a certain amount of security, knowing that if they fall or have some other kind of medical emergency, the individual can press a button on the wearable transmitter and call for help. Unfortunately for some, a catastrophic event may overcome them too quickly to press the alert button. Conversely, a medical event may overcome at risk individuals too slowly for the individuals to recognize that a serious problem exists; for example, without limitation, they may slowly lapse into a coma, thinking they are just “taking a nap.” In either case, a serious medical condition may exist with no means for rapid notification of the proper medical authorities.

Prior art solutions address, among other issues, the problems associated with individuals who have the potential to become unconscious before they are able to call for help. What is described in the prior art is a computer-based monitoring system that incorporates room-based, area-based, or attachable sensors that detect, among other signs of distress, a lapse in movement by the subject. In such a case, the alert is caused when one or more of the thresholds of inactivity are exceeded for a time period. Prior art also discloses the software functionality that is required for critical system performance. Limitations of such a system are numerous.

As disclosed, the prior art computer-based system imposes a degree of complexity (and inherent cost) that may not be required for many situations of at risk individuals. A simpler system may lead to a lower-cost, more-affordable solution that could adequately meet the needs of said individuals.

A main limitation of prior art computer-based systems relates to the use of computers in medical alert situations, especially in applications where a computer is incorporated as an integral part of the wearable or attachable unit. Computers, or micro-controllers as may be applied, consume less-than-negligible power, and often in remote-control applications, their use is limited to intermittent operation in miniature units or continuous operation in larger, often-not-wearable units. Although various sleep modes of micro-controllers may be incorporated to reduce power, it is normally at the expense of external (to the micro-controller) complexity.

Having the computer located in a fixed-base monitoring station is also problematic. In such an implementation the remote or wearable lack-of-activity sensor may need to communicate frequently with the fixed-base monitoring station that has the appropriate signal processing software. Because this method requires frequent radio frequency (RF) or other wireless transmissions, it is also a relatively high-power implementation, requiring the remote unit to contain a large battery as a power source or alternatively, requiring frequent change of batteries. The large size and weight of a system using a large battery may discourage the use of the system as a wearable device, and the frequent change of batteries, if small batteries are used, may discourage use and increase the risk of a dead battery being left in the device. Furthermore, additional circuitry to address power issues may add cost and complexity to the system.

Overall, the use of a computer, either in the remote unit or in a fixed base station, entails a host of power supply issues that preclude an efficient, compact, low-cost medical alert system.

In view of the foregoing, there is a need for an improved wearable medical alert system that addresses the power supply issue and reduces the power and size of the remote control unit.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an exemplary remote control unit for an alert system, in accordance with an embodiment of the present invention;

FIG. 2 is a block diagram illustrating an exemplary alert signal receiver module for an alert system, in accordance with an embodiment of the present invention;

FIG. 3 is a side perspective view of an exemplary pendant style remote control unit for an alert system, in accordance with an embodiment of the present invention;

FIG. 4 is a side perspective view of an exemplary alert signal receiver module for an alert system, in accordance with an embodiment of the present invention; and

FIG. 5 is a block diagram of an exemplary remote control unit for an alert system, in accordance with an embodiment of the present invention;

FIG. 6 is a schematic diagram of the circuitry of an exemplary remote control unit of an alert device, in accordance with an embodiment of the present invention;

FIG. 7 is a schematic diagram of the circuitry of an exemplary motion detector and counting device of a remote control unit of an alert device, in accordance with an embodiment of the present invention;

FIG. 8 is a schematic diagram of exemplary circuitry of a motion detector and counter of an exemplary remote control unit of an alert device, in accordance with an embodiment of the present invention; and

FIG. 9 is a schematic diagram of exemplary circuitry of a motion detector and counter of an exemplary remote control unit of an alert device, in accordance with an embodiment of the present invention.

Unless otherwise indicated illustrations in the figures are not necessarily drawn to scale.

### SUMMARY OF THE INVENTION

To achieve the forgoing and other objects and in accordance with the purpose of the invention, a medical safety monitor system is presented.

In one embodiment, a wearable medical alert apparatus is presented. The apparatus includes a housing for containing the apparatus wearable by an individual. A motion sensor is contained within the housing. The motion sensor outputs a signal indicative of motion of the individual where an absence of signal indicates a potential need for medical assistance for the individual. Low power circuitry is contained in the housing for processing the signal to determine the absence of signal. The circuitry outputs a first signal after a first period of time when the absence of signal has been detected for a duration of the first period of time and a second signal, after a second period of time, the second period of time being substantially longer than the first period of time, when the absence of signal has been detected for a duration of the second period of time. A transmitter, contained in the housing, responsive to the first and second signal transmits an alert signal indicating need for the medical assistance when the first signal and the second signal is output by the circuitry. The alert signal is repeated at intervals of the first period of time.

Further embodiments include a first switch, contained in the housing, operable to cancel transmission of the alert signal when activated and a second switch, contained in the housing, operable to enable the transmitter to transmit the alert signal when activated. In another embodiment, the motion sensor further outputs a large signal indicative that the individual has fallen and potentially needs medical assistance, the circuitry processes the signal to determine the large signal and outputs a third signal in response thereof and the transmitter responsive to the third signal for outputting the alert signal. Other embodiments include means for adjusting a threshold for detection of the absence of signal and means for adjusting the duration of the second period of time. In yet another embodiment, the circuitry includes discrete analog and logic components to minimize the power requirements. In still another embodiment, the transmitter is configured for short-range transmission to a dedicated receiver.

In another embodiment, a wearable medical alert apparatus is presented. The apparatus includes means for containing the apparatus wearable by an individual, means for outputting a signal indicative of motion of the individual where an absence of signal indicates a potential need for medical assistance for the individual, means for processing the signal to determine the absence of signal and outputting a trigger signal indicating that the absence of signal has been detected for a duration and means for transmitting an alert signal in response to the trigger signal. Further embodiments include means for canceling transmission of the alert signal and means for manually triggering the transmitter to transmit the alert signal. Another embodiment further includes means for detecting a large signal indicative that the individual has fallen and potentially needs medical assistance and triggering the transmitter to output the alert signal. Other embodiments include means for adjusting a threshold for detection of the absence of signal and means for adjusting the duration.

In another embodiment, a medical alert system is presented that including a remote control unit including a housing for containing the unit wearable by an individual. A motion sensor is contained within the housing. The motion sensor outputs a signal indicative of motion of the individual where an absence of signal indicates a potential need for medical assistance for the individual. A low power circuitry, contained in the housing, processes the signal to determine the absence of signal. The circuitry outputs a first signal after a first period of time when the absence of signal has been detected for a duration of the first period of time, and the circuitry outputs a second signal after a second period of time, the second period of time being substantially longer than the first period of time, when the absence of signal has been detected for a duration of the second period of time. A transmitter, contained in the housing, is responsive to the first and second signal for transmitting an alert signal indicating need for the medical assistance when the first signal and the second signal is output by the circuitry. The alert signal is repeated at intervals of the first period of time and a first switch, contained in the housing, is operable to cancel transmission of the alert signal when activated. An alert signal receiver module includes a receiver configured to receive the transmitted alert signal and an alert module for notifying proper authorities of a medical or situation. Another embodiment includes a second switch, contained in the housing, operable to enable the transmitter to transmit the alert signal when activated. In a further embodiment, the motion sensor further outputs a large signal indicative that the individual has fallen and potentially needs medical assistance. The circuitry processes the signal to determine the large signal and outputs a third signal in response thereof and the transmitter responsive to the third signal outputs the alert signal. Further embodiments include means for adjusting a threshold for detection of the absence of signal and means for adjusting the duration of the second period of time. In yet another embodiment, the circuitry includes discrete analog and logic components to minimize the power requirements.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

The preferred embodiment of the present invention incorporates a sensor to detect a lack-of-activity condition that is consistent with an unconscious or immobile person, and provides a means to automatically notify authorities. The preferred embodiment, which is based on low-power discrete logic, substantially reduces power requirements compared to the prior art and provides the capability for a low-maintenance, low cost, wearable device that is easily incorporated into existing medical alert designs.

In the preferred embodiment, no computer is required, and therefore no operational software is needed. The use of discrete logic, which uses no computer or micro-controller, substantially lowers the wearable device power requirement, typically 100 times less than comparable performance micro-controllers, thus enabling simplified, battery-powered operation. Low power requirements in the preferred embodiments enable the wearable devices to be miniaturized into a pendant or wristband because the batteries or other power sources become smaller. Low power requirements also mean that few, if any, battery changes are required. In the preferred embodiment, signal processing is performed on-board the wearable device, allowing for a simple design of the receiver module and alert notification. Furthermore, the design of existing manual push-button alert medical pendants or wristbands can be easily modified to incorporate the additional medical safe guards provided by the preferred embodiment of the present invention. An entirely new monitoring system is not required to provide an additional layer of safety.

Prior art medical alert devices, such as, but not limited to, the “Life Alert” system, limit the functionality of the remote, wearable unit to a transmitter, an alert button, a receiver, and notification system. The preferred embodiment of the present invention provides the same functionality yet adds a critical safety feature with minimal added cost and size.

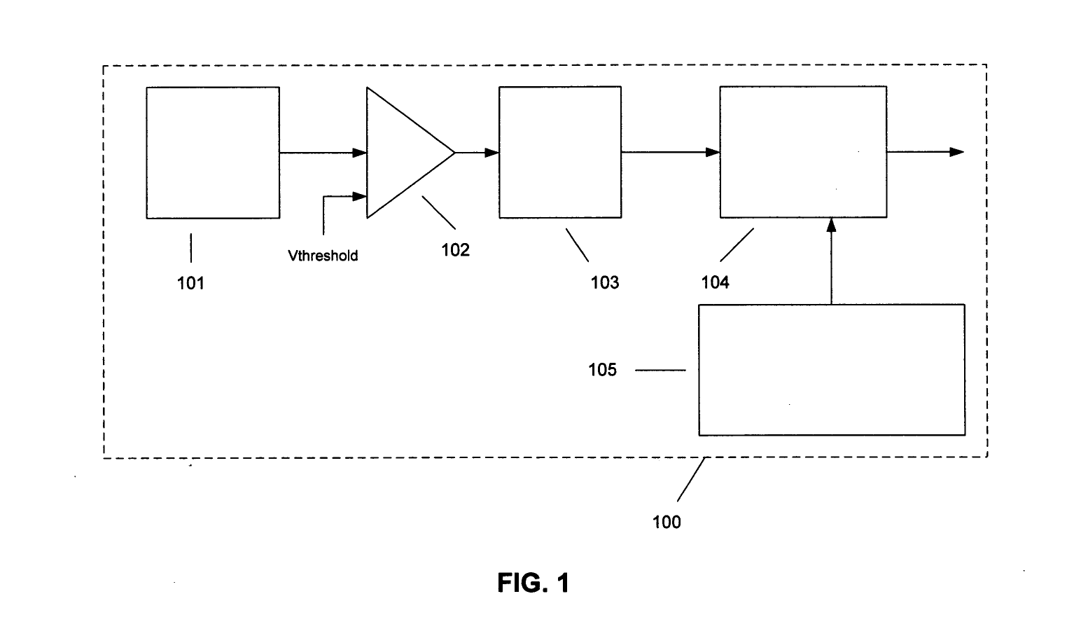

FIG. 1 is a block diagram of an exemplary remote control unit 100 for an alert system, in accordance with an embodiment of the present invention. The present embodiment comprises five main components in remote control unit 100, a motion detector 101, a voltage threshold comparator 102, a counter 103, a transmitter 104, and a button 105. In the present embodiment, motion detector 101 is an accelerometer or piezo movement sensor that outputs an analog signal. The amplitude and frequency of the analog signal output by motion detector 101 depends on the movement of the user of remote control unit 100 and also on sensor selection and design. With commonly available sensors, the signal may resemble a series of damped sine waves that is several hundred millivolts or several volts maximum during normal user motions.

The input threshold of comparator 102 is set at a level that is consistent with normal user activity. For example, without limitation, if the user is inactive or motionless, the output of comparator 102 is low. However, if the user is active, comparator 102 typically outputs a series of rapid pulses, for example, without limitation, several pulses over a 100-millisecond period, whenever movement occurs. The logic level output of comparator 102 becomes a reset signal that is applied to the next stage. The threshold of comparator 102 may be set by the system manufacturer, or in some embodiments, may be set by the system user or by a caregiver of the at risk user.

In the present embodiment, counter 103 is a binary counter, however in alternate embodiments, the counter may be another type of counter, for example, without limitation, a decade or other periodic counter. In absence of a reset signal, counter 103 increments a count, since absence of a reset signal indicates that the user is motionless. Typically the count is incremented every five seconds, and for normal activity and motion, this timer function is reset every several minutes back to a count of zero. After a manufacturer-defined or user-defined interval, the output, in absence of a reset signal, asserts a voltage on transmitter 104, indicating that an alert should be sent. Typically, the alert may be sent after an hour of inactivity during the daytime or eight hours of inactivity at night; however, these time limits may be longer or shorter depending on the typical activity level of the user. In the present embodiment the system manufacturer, system user, or a caregiver may adjust the threshold level of inactivity with respect to factors such as, but not limited to, time, time of day, period of time, level of activity, or any combination of said modifiers. Some embodiments may be configured to be used as a fall detector. In these embodiments the motion detector can detect a motion that would indicate a fall, for example, without limitation, a sudden, violent motion, and the transmitter then sends an alert to the receiver.

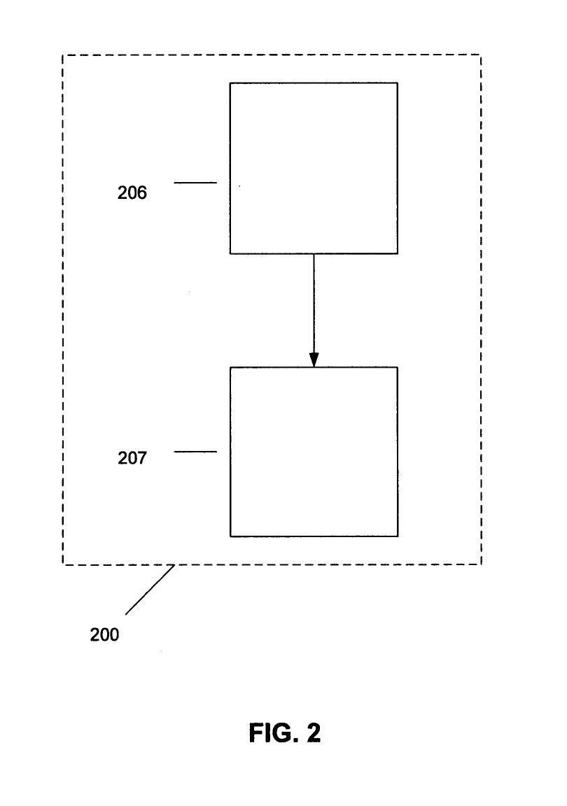

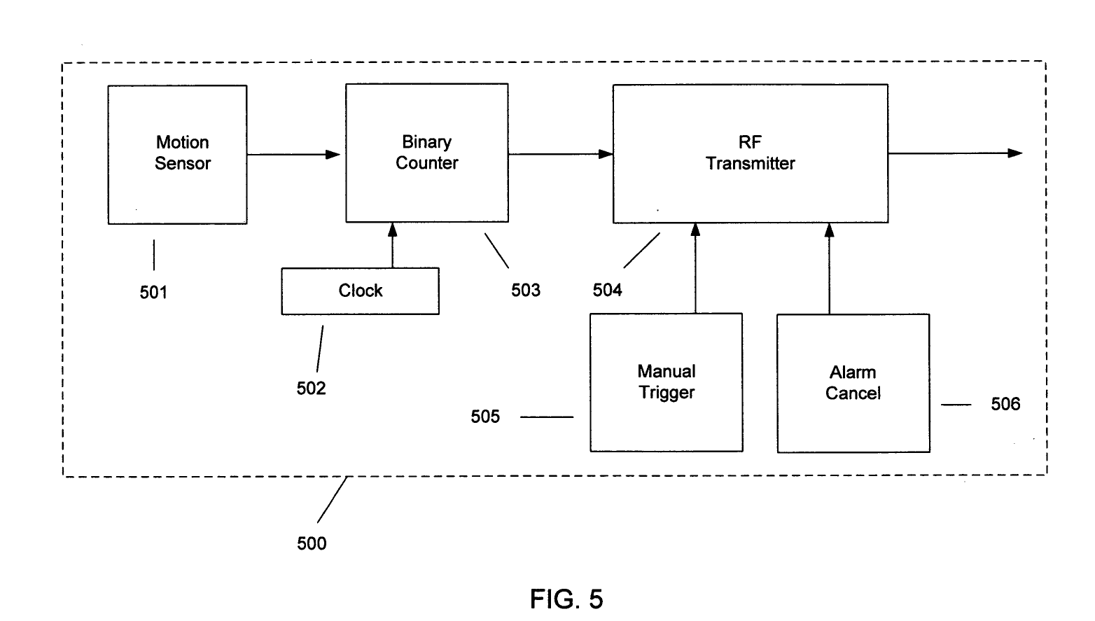

In the present embodiment, once counter 103 increments the set count to indicate motionlessness, transmitter 104 subsequently transmits a radio frequency (RF) signal to an alert signal receiver 200, shown by way of example in FIG. 2. As is normal on common alert devices, button 105 can be pressed by the user to manually alert authorities in the event of an emergency where the user is conscious. As, shown by way of example in the embodiment illustrated in FIG. 5, some embodiments may also comprise an alarm cancel button that can be pressed by the user if the alert system is activated needlessly, for example, without limitation, by accident.

In the present embodiment, motion detector 101, comparator 102 and counter 103, if implemented using standard, non-micro-controller, CMOS components, typically require a combined power supply current of less than 1 microampere, and this enables convenient battery operation. Transmitter 104 is a higher-power device or assembly, often using 2-5 milliamperes; however, this current is only required when an alert is to be sent, which for most users, is an uncommon event. Implementing the same functionality using a micro-controller or micro-computer, as used in the prior art, may require over 200 microamperes of continuous power supply current, thus precluding an efficient and compact remote control unit.

FIG. 2 is a block diagram illustrating an exemplary alert signal receiver module 201 for an alert system, in accordance with an embodiment of the present invention. In the present embodiment, alert signal receiver module 201 comprises a receiver 206 coupled to an alert module 207, which may be, for example without limitation, an automatic phone dialer or a hospital desk monitor. The transmitter in the remote control unit sends an RF signal to receiver 206 and alert station 207, which notifies the proper authorities of the medical or emergency situation. Various embodiments may comprise transmitter means that enable short-range transmission to a dedicated home, apartment, or medical center receiving station, longer-range transmission for example, without limitation, to a wireless paging network, a cellular network, a similar network, or a combination of such networks.

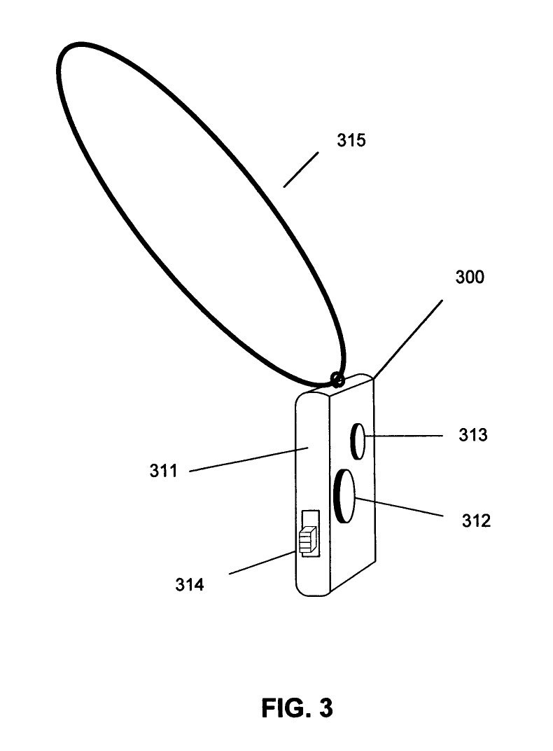

FIG. 3 is a side perspective view of an exemplary pendant style remote control unit 300 for an alert system, in accordance with an embodiment of the present invention. Remote control unit 300 may comprise components such as, but not limited to, the components shown by way of example in FIG. 1 or FIG. 5 in its interior. In the present embodiment an exterior body 311 of remote control unit 300 comprises an alert button 312, a cancel alert button 313, and a power switch 314. Alert button 312 enables the user of remote control unit 300 to manually and remotely activate a monitoring station, such as, but not limited to, alert signal receiver module 201 shown by way of example in FIG. 2, to send an alert signal indicative of a medical emergency to the proper authorities. In some embodiments the user may also be able to set up or change these modifiers such as, but not limited to, the threshold level of activity with respect to time, time of day, period of time, and level of activity using buttons or switches on remote control unit 300. Some embodiments may also comprise a display such as, but not limited to, an LED display, that shows the status of the user and the current settings of the system. In the present embodiments remote control unit 300 is worn as a pendant with a cord 315 around the neck of the user; however, in alternate embodiments the remote control unit may be modified for use as a wristband. In either implementation the remote control unit is typically about the same size as a wireless car key device.

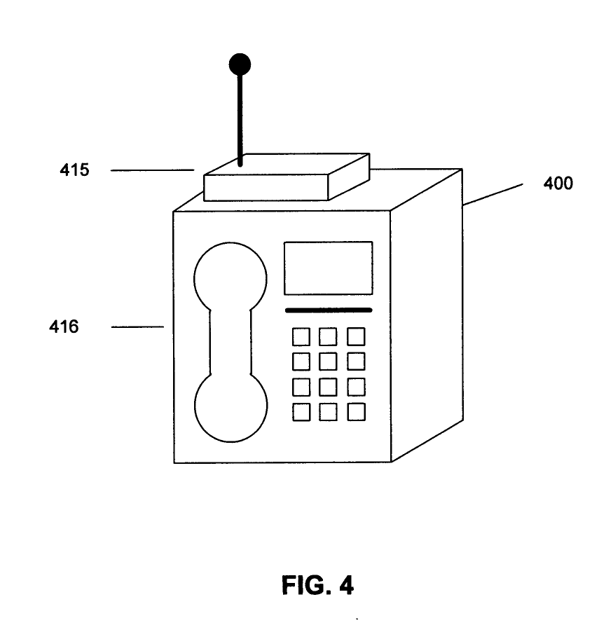

FIG. 4 is a side perspective view of an exemplary alert signal receiver module 400 for an alert system, in accordance with an embodiment of the present invention. In the present embodiment, alert signal receiver module 400 receives alert signals from a transmitter of a remote control unit through an RF receiver 415. Then, an automatic call center 416 notifies the proper authorities, for example, without limitation, emergency personnel, that there may be an emergency. Alternate embodiments may comprise an alert module that produces an alarm or voice alert when a signal is received from a remote control unit instead of an automatic call center. These embodiments may be particularly useful in a hospital or other health care providing environment.

FIG. 5 is a block diagram of an exemplary remote control unit 500 for an alert system, in accordance with an embodiment of the present invention. In the present embodiment, there are four main components of remote control unit 500, a motion detector 501, a clock 502, a binary counter 503, and an RF transmitter 504. Remote control unit 500 also comprises an alert button 505 and an alert cancel button 506. In the present embodiment, motion detector 501 is a rolling ball switch and pull-up resistor that outputs a logic reset signal whenever a significant movement is detected. The signal is normally a series of “chatter” pulses that quickly cease when motion halts. The current requirement of motion detector 501 depends on the value of the pull-up resistor, typically 5 megaohms, and is therefore less than 0.6 microamperes, assuming a 3-volt power source. In the present embodiment, clock 502 uses a low frequency of 0.25 Hz. However, in alternate embodiments, the clock may use various different frequencies.

Binary counter 503 is a logic counter that has two inputs, a reset signal from motion detector 501 and a signal from clock 502. In absence of a reset signal from motion detector 501, increments a count. Typically the count is incremented every five seconds, and for normal activity and motion, this timer function is reset every several minutes back to a count of zero. After a manufacturer-defined or user-defined interval, the output, in absence of a reset signal asserts a voltage on transmitter 504, indicating that an alert should be sent by transmitter 504. Typically, the alert may be sent after an hour of inactivity during the daytime or perhaps eight hours of inactivity at night. Again, these intervals may be set by the manufacturer or by the user and may vary depending on the use of the intended use of the alert system.

As in the embodiment shown by way of example in FIG. 1, if implemented using standard, non-micro-controller, CMOS components, typically requires a power supply current of less than 1 microampere, and this also allows convenient battery operation. Transmitter 504 is a higher-power device or assembly, often using 2-5 milliamperes, however this current is only required when an alert is to be sent, which for most users, is an uncommon event. Those skilled in the art, in light of the present teachings, will recognize that various different types of motion detectors and counters may be used in various combinations in alternate embodiments.

In the present embodiment, alert button 505 enables the user to manually initiate a signal from transmitter 504 to notify the proper authorities that there is a medical emergency. Alert cancel button 506 enables the user to cancel an alert that has been transmitted.

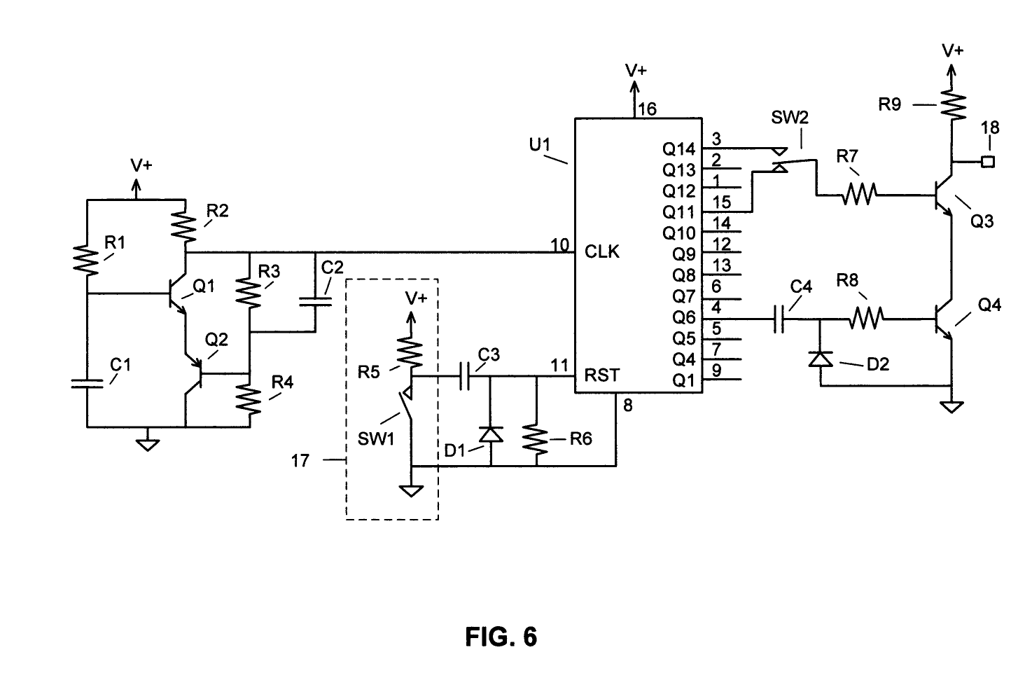

FIG. 6 is a schematic diagram of the circuitry of an exemplary remote control unit of an alert device, in accordance with an embodiment of the present invention. In the preferred embodiment, the remote control unit also comprises a transmitter, an alert button and a cancel button. Furthermore in the preferred embodiment a receiver with means for notification receives alert signals from the remote control unit. The circuitry in the preferred embodiment for the transmitter, alert button, cancel button, receiver, and notification means are known to those skilled in the art for the field of remote medical alert devices, and, as such, are described in generality.

The motion detector, as shown by way of example as motion detector 501 in block diagram format in FIG. 5, is shown by way of example schematically as item 17 in FIG. 6.

In the present embodiment, a switch SW1 comprises a Micro-Electro-Mechanical System (MEMS) device such as, but not limited to, a rolling ball switch that is sensitive to vibration or position. Typically such a switch is cylindrical, about 2.5 mm in diameter, 6 mm in length, and easily fits within the confines of a pendant or wristband housing. However, switches of varying sizes and shapes may be used in alternate embodiments. In the present embodiment, a pull-up resistor R5 with a resistance of about 5.1 M ohms, in conjunction with the opening and closing of switch SW1, outputs a logic signal whenever a significant movement is detected. The signal is normally a series of “chatter” pulses that quickly cease when motion halts. Said logic output connects to a reset pin 11 of a counter U1 of a binary ripple counter, CD4020B in the present embodiment, via a coupling capacitor C3. The fabrication of switch SW1 is such that normally a high or low output cannot be guaranteed for any unique position, but that switch SW1 opens and closes upon significant movement. A resistor R6 of approximately 22 M ohms generally assures that, in absence of movement, reset pin 11 of counter U1 remains low, thereby allowing counter U1 to increment a count. A diode D1 is a general-purpose diode that, for negative-going transitions of said motion detector signal, limits negative voltage excursions on reset pin 11 of counter U1, thus precluding possible damage to a U1 CMOS input.

A free-running pulse generator, connecting to a clock input pin 10 of counter U1, comprises resistors R1 through R4, capacitors C1 and C2, and transistors Q1, and Q2. In the present embodiment, the pulse generator operates with a pulse frequency of about 0.25 Hz and has a normally high output, pulsing low for about 5 milliseconds every 4 seconds. The values for resistors R1 through R4 are selected for both low-frequency timing and low current drain, and for the present embodiment the pulse generator circuit requires less than 1 microampere combined. Typical values for resistors R1, R2, R3, and R4 are 22 M ohms, 470 K ohms, 5.1 M ohms, and 5.1 M ohms respectively. However, in alternate embodiments these resistors may have various different values. Precision is not critical, and 5% tolerance resistors generally suffice for this application. Likewise, transistors Q1 and Q2 are general purpose, small-signal NPN and PNP transistors. In the present embodiment, the value of capacitor C1 is a 0.22 microfarad, and C2 is 0.01 microfarad, and again, the precision of said values are not critical, and a 10% tolerance often suffices.

Also, exact power supply voltage is not critical, with 3V-12V being a nominal range. However, for purposes of the present embodiment, component values are optimized for a 3V power supply, which is compatible with the output of a lithium battery.

In absence of a reset signal presented at reset pin 11 of counter U1 indicating that the user is motionless, counter U1 increments a count as indicated by its output pins Q1 and Q4 though Q14. For normal user activity and motion during waking hours, this timer function is reset in the present embodiment every several seconds or minutes back to a count of zero. During periods of inactivity, the U1 count continues to increment. If no reset pulse occurs during a preset time interval, approximately 4 minutes in the present embodiment, a positive-going output at pin 4 of counter U1 sends a current pulse via a capacitor C4 and a resistor R8 to the base of a transistor Q4. However, because the output signal at a pin 15 of counter U1 is, shortly after reset, low, no current flows through a resistor R7 and therefore, no current flows into the base of a transistor Q3, so the “AND-connected” transistor pair of Q4 and Q3 remains off, for example, without limitation, no collector current flows. The use of a 4-minute signal in the present embodiment will be apparent shortly. However, alternate embodiments may be configured with varying signal intervals.

After slightly more than an hour with no reset pulses, counter U1 asserts a high-level logic output at pin 15. With resistor R7 having a value of 2 M ohms in the present embodiment, an approximate 1 microampere current flows into the base of transistor Q3. As pin 4 of counter U1 also goes high simultaneously, a current pulse of 1 microampere, with a capacitor C4 value of 0.22 microfarad and a resistor R8 value of 2 M ohms in the present embodiment, flows into the base of transistor Q4 for about a half-second. With both transistors Q3 and Q4 enabled, a trigger pulse from a collector 18 of transistor Q3 and a resistor R9, with a value of about 100 K ohms, is sent to the following radio frequency (RF) transmission stage, indicating that an alert signal should be sent. The half-second signal is functionally equivalent to an “at-risk” patient pressing the alert button. And because the signal of transistor Q4 is derived from the 4-minute positive-going output of counter U1 in the present embodiment, the alert signal is repeated at 4-minute intervals. For negative-going signals of pin 4 of counter U1, a diode D2 discharges capacitor C3 into a ground. Those skilled in the art, in light of the present teachings, will recognize that various different values may be used for the various components of the circuitry depending on the configuration of the system.

In the present embodiment, transistors Q3 and Q4 are general-application, small-signal transistors. Likewise, resistors R7 and R8, capacitor C4, and diode D2 are general-purpose components with minimal precision requirements. In the present embodiment, a trigger output 18 is configured such that the RF section transmits an output alert with a low-level trigger. If the RF section requires a high-level trigger, an inverter may be incorporated at the base of transistor Q3: the design of such comprises standard techniques that are known to those skilled in the art. A switch SW2 enables the lack-of-motion time interval to be selectable. If, for some reason, the “at-risk” user expects to be essentially motionless during, for example, without limitation, an 8-hour sleep period, the user can select a 9-hour alert delay, wherein transistor Q3 is not be energized and pin 3 of counter U1 does not go high until a total of 9 hours of count increments have accumulated.

Different embodiments of the present invention may comprise variations of components and functions. For instance, without limitation, it may be desirable to incorporate switch SW2 as part of the functionality of a “false-alarm” button that is present on many alert pendants. For example, without limitation, a quick press of the “false-alarm” button may enable the circuit to trigger on half-hour periods of inactivity, subsequent presses may indicate for example, without limitation, a 1-hour trigger threshold, 2 hours, etc. If so, additional low-power logic may readily incorporate this feature.

Similarly, said control, in still another embodiment, may also enable the user to turn off the motion sensing function of the remote, allowing a simpler push-the-button method of calling for help. Said feature is also useful in the event that the “at-risk” user, for any reason, decides to set the device aside, for example, without limitation, on a table or in a drawer. In such case, the remote control unit, sensing a lack-of-motion, sends an alert to the monitoring station, generating a false alarm. An “off” feature, such as, but not limited to, a separate switch on the remote control unit, could preclude such an event.

One skilled in the art, in light of the present teachings, will recognize that a large variation of control modes may be encompassed in an alert apparatus formed in accordance with the present invention.

As stated earlier, the use of precision components is generally not required, however, if tighter timing control, for example, without limitation, of 1.1-hour and 9-hour count intervals, is seen as beneficial, the tolerances of resistor R1 and capacitor C1 can be tightened accordingly, inasmuch as said resistor and capacitor values set the overall timing of the pulse generator and therefore the system. If, for instance without limitation, the capacitance of capacitor C2 is 10% higher than nominal, the 9-hour interval becomes 9 hours and 54 minutes. Alternatively, if the variation of capacitor C2 is 1%, assuming the value of R1 is precise, then said timing interval becomes about 9 hours and 6 minutes at worst case.

Although there are various industry-standard methods to more-accurately control such timing circuits that may be used in alternative embodiments of the present invention, a reasonable, cost-effective embodiment comprises component selection such that, at worst case, the lack-of-motion interval is no more than 9 hours, nominally ranging, for example, without limitation, from 8 hours minimum to 9 hours maximum.

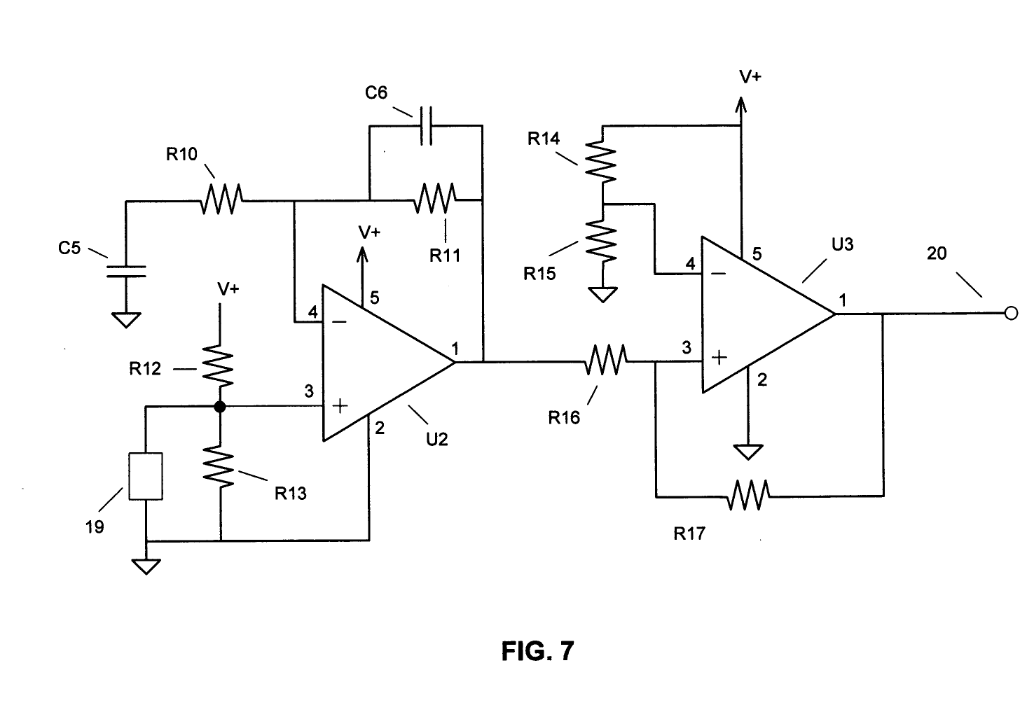

An alternate method of motion sensing is shown in FIG. 7. FIG. 7 is a schematic diagram of the circuitry of an exemplary motion detector and counting device of a remote control unit of an alert device, in accordance with an embodiment of the present invention. In the present embodiment, the circuit, comprising a piezo film sensor 19, as shown by way of example in motion detector 101 in FIG. 1, support electronics resistors R10 through R17, capacitors C5 and C6, amplifier U2, and comparator U3, is functionally represented by way of example in FIG. 1 by motion detector 101. In the present embodiment, piezo film sensor 19 is typically 1 cm by 2 cm by 110 microns in size and can be modeled as a 480 pico-farad capacitor that outputs a charge when bending of the film occurs, the amount of charge being dependent on the amount of bending. However, in alternate embodiments, sensors of various size and sensitivity may be used.

With typical user motion, piezo sensor 19 vibrates and outputs a low current, under 5 nano-coulombs, that converts to a voltage via resistors R12 and R13 that have resistances of about 1 M ohm each. This creates a signal that, depending on damping and resonance of the detector assembly, resembles a series of damped sine waves: a 10-Hertz, 10 millivolt damped signal is not be uncommon. Such a signal, in the present embodiment, is further processed via amplifier U2, for example, without limitation, a LPV511. Amplifier U2 is an operational amplifier with a nominal supply current of under a microampere. Resistors R12 and R13 form a resistor divider at a non-inverting input of amplifier U2 that, in absence of a signal, forces the output of amplifier U2, Pin 1, to be at 1.5V, assuming a power supply voltage of 3 volts. Resistors R11 and R10 and a capacitor C5, with values 5.1 M ohms, 550 K ohms, 0.1 microfarad respectively in the present embodiment, configure amplifier U2 into a high-pass filter, with a lower cutoff frequency around 1.5 Hz, that provides a signal gain of ten at frequencies of interest, 10 Hz and above. A capacitor C6, typically 10 pico-farads, reduces the high-frequency amplifier destabilization effect that stray input capacitance has at pin 4 of amplifier U2, for example, without limitation, through standard pole-compensation method.

The output signal of amplifier U2 is subsequently applied to a threshold comparator circuit comprising comparator U3 and resistors R14 through R17. In the present embodiment, comparator U3 is an LPV511, configured as a comparator, and typical resistor values of resistors R14, R15, R16, and R17 are 4.3 M ohms, 2 M ohms, 1 K ohm, and 1 M ohm respectively. In alternate embodiments, a different comparator may be used and the resistors may have various different resistances depending of the configuration. For the present embodiment, said circuit provides a threshold voltage of 1 volt at the inverting input of comparator U3. In conjunction with resistors R16 and R17, the threshold voltage provides a slight positive feedback of an output logic signal of comparator U3 to the non-inverting input of comparator U3, thus providing some hysteresis and noise reduction due to slowly-changing input signals. The output of amplifier U2, pin 1, is applied to an AC coupled circuit comprising capacitor C3 and resistor R6, as shown by way of example in FIG. 6. Thus, the motion-detector circuit shown by way of example in FIG. 7 functionally replaces item 17 as shown by way of example in FIG. 6. In a similar manner to the rolling-ball-switch method of item 17, the piezo vibration sensor in accordance with the present embodiment, with its support electronics, provides a reset signal to counter U1, shown by way of example in FIG. 6, whenever the at-risk patient moves.

Component configuration and component values stated in the present embodiment are selected for low-current function and are typical for such an application, however one skilled in the art could easily modify said application circuit to suit particular needs in alternate embodiments.

The benefits of a piezo-detector system according to embodiments of the present invention are two-fold. A piezo-detector system can detect changes in normal patient movement, for example, without limitation, function as a lack-of-movement detector, and a piezo-detector system can incorporate slight modifications to function as a fall detector in some embodiments. For example, without limitation, when a patient falls, acceleration forces are severe, and as such, piezo sensor deflections are proportionately strong and hence detectable. In such an event, a signal could be detected by a dedicated threshold comparator, wherein said comparator immediately triggers a RF transmitter to send an alert.

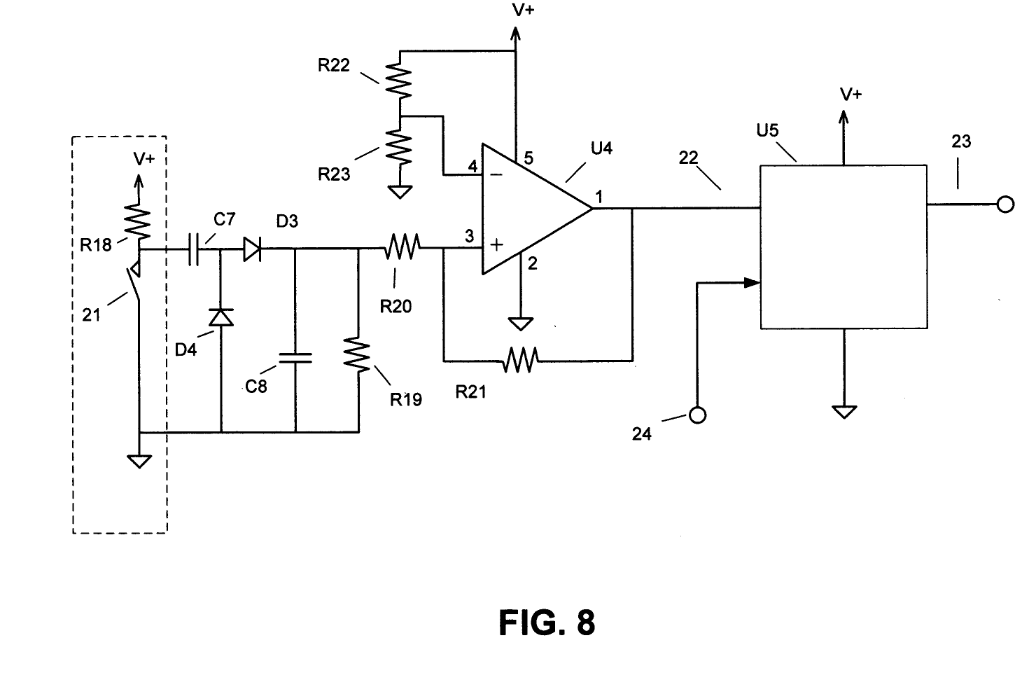

FIG. 8 is a schematic diagram of exemplary circuitry of a motion detector and counter of an exemplary remote control unit of an alert device, in accordance with an embodiment of the present invention. In the present embodiment, a microcontroller U5 performs part of the remote unit signal processing and control. Such an embodiment may be beneficial if a significant number of features, such as, but not limited to, motion sense off-and-on, multiple lack-of-motion intervals, sensitivity adjust (as with a piezo motion sensor or fall detector means), are incorporated. As stated earlier, a microcontroller-based remote entails further complexity to both maintain both low power and increased functionality. However, some users may desire a personal alert system with added features and flexibility.

In the present microcontroller embodiment, some analog processing is still required, and this is disclosed first. As with the previously disclosed analog circuit shown by way of example in FIG. 6, a rolling-ball switch 21 is used as a motion sensor. A resistor R18, a 1 M ohm resistor, functions as a pull-up resistor to the positive power supply, and switch 21 in conjunction with resistor R18, upon motion, outputs a series of “chatter” pulses that couple to a capacitor C8 (0.1 microfarad) via a diode D2 and a capacitor C7 (also 0.1 microfarad). The effect of signal diodes D3 and D4 is such that said pulses accumulate a voltage on C8 that can, depending on the number of pulses received, approach the power supply voltage. Upon the halting of motion, a resistor R19, 1 M ohm, slowly discharges the voltage on capacitor C8, of which the time constant of the R-C network is 0.1 second. This voltage is then applied a threshold comparator circuit comprising a comparator U4 and resistors R20 through R23, the general operation of which has been described earlier in this disclosure. Said comparator threshold (about 0.1 volts at a pin 4 of comparator U4) is such that an output level of comparator U4 remains high for several tenths of a second after significant motion has stopped by the “at-risk” user.

This enables microcontroller U5 to sample the comparator voltage at relatively long intervals, 0.3 seconds for example without limitation, and remain in sleep mode between samples. A built-in watchdog timer can enable many microcontrollers to perform this timing function without the need for an external clock. However, during sleep modes, many microcontrollers also require, for low-power input CMOS operation, that voltages at an input 26 are a logical high or low, hence the need for an external comparator. Additionally, MEMS rolling-ball switches that are in present production do not always provide a solid high or low logic output. The embodiment shown by way of example in FIG. 6, as described earlier, uses a CD4020B, which has a Schmitt-triggered reset input, and is therefore insensitive to rise and fall times of applied inputs. Therefore, a ragged transition of a rolling-ball switch presents no problem. With microcontrollers, however, power supply current can increase significantly with an indeterminate input state. Hence a carefully controlled input, or a microcontroller with enhanced input control, or a motion sensor with clean and rapid transitions between logic states may be required in embodiments using microcontrollers. Improvements in microcontroller technology or MEMS sensors may enable a significant reduction in parts count while retaining desired features and functionality. Several varied embodiments of this pulse-stretching method should be readily apparent to those practiced in the art in light of the present teachings.

Part of the signal processing of microcontroller U5 is to monitor the amount of “quiet time,” intervals wherein no movement is detected. Similar to the function and operation of the discrete-component circuit shown by way of example in FIG. 6, microcontroller U5, upon determining that a significant lapse in movement has occurred, sends a trigger signal 23 to an RF transmitter stage. The RF transmitter subsequently sends an alert to the receiving and monitor station, thereby, in turn, alerting the proper caregiver authorities.

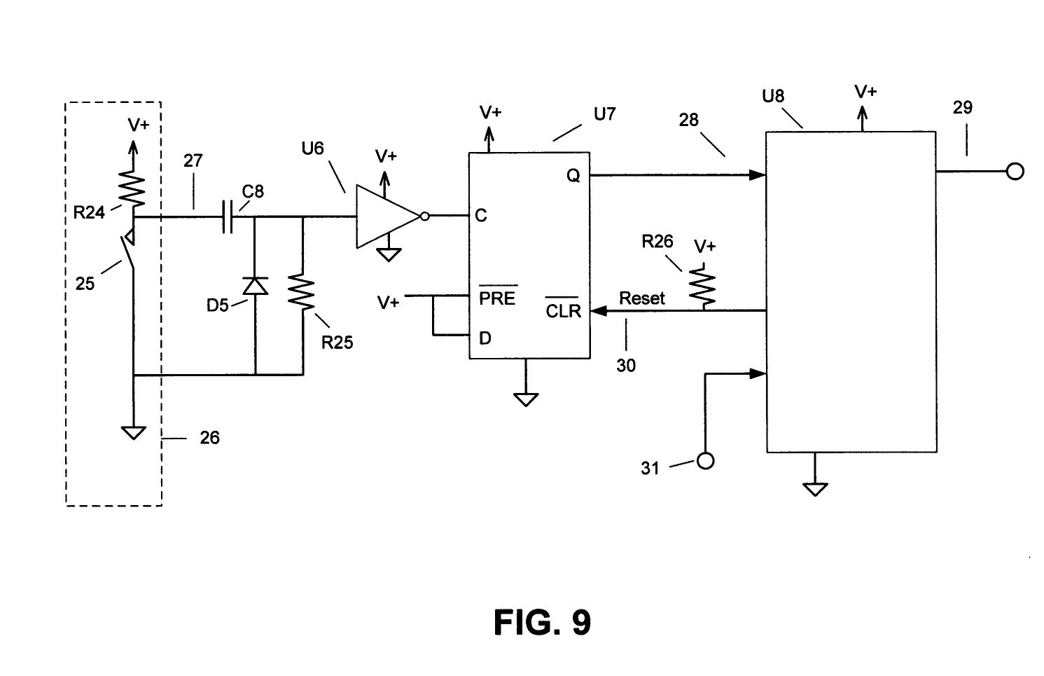

FIG. 9 is a schematic diagram of exemplary circuitry of a motion detector and counter of an exemplary remote control unit of an alert device, in accordance with an embodiment of the present invention. The present embodiment is yet another low-power embodiment and incorporates a Schmitt-triggered device, such as, but not limited to, a CMOS inverter U6, connected to a CMOS flip-flop comparator U7, wherein inverter U6 connects directly to an output signal 27 of a rolling-ball-switch 25 and a pull-up resistor combination 26. In the present embodiment, transitions of switch 25, which are indicative of patient motion, are latched by comparator U7. As earlier discussed, a capacitor C8, a diode D5, and a resistor R25 enable AC coupling of output signal 27 and assert a low state at the input of inverter U6 during periods of non-motion. Upon receiving a clock signal from comparator U7, output 28 switches to a high state and maintains said high state until a microcontroller U8 awakens and asserts a low voltage on a flip-flop clear signal 30 of comparator U7. Resistor R26, nominally 1 M ohm, assures that clear signal 30 remains high while microcontroller U8 is in high-impedance sleep mode. Thus, in the present embodiment, a signal indicative of patient motion is held for an indefinite time, enabling microcontroller U8 to sample at an interval, for example, without limitation, every ten seconds, which allows for exceptionally low-power operation. At the end of the interval, comparator U7 is reset and subsequently waits for another pulse of output signal 27 that indicates motion. Again, if no motion-indicative pulses are received during an interval, for example, without limitation, microcontroller U8 asserts a signal at an output 29 triggering the RF transmitter stage.

As shown by way of example in both FIG. 8 and FIG. 9 an additional microcontroller input, for example, without limitation, an input 24 or an input 31, can be used to sense switch activation, sense status of a “fall” sensor, or output a signal to an LED display. Similarly, a microcontroller could also incorporate the RF coding function, for example, without limitation, as a remote unit identification digital code, as part of the firmware, thus allowing a simpler overall design and integration of the remote unit components. Further details on interfacing, software and firmware design techniques should be apparent to those familiar with the art in light of the present teachings.

Having fully described at least one embodiment of the present invention, other equivalent or alternative means for implementing a medical safety monitor according to the present invention will be apparent to those skilled in the art. For example, without limitation, the above embodiments describe a wearable device that is a pendant or a wristband. However, alternate embodiments may be worn differently. For example, without limitation, some embodiments may clip onto a belt or the clothing of the user. Yet other embodiments may be carried in the pocket of the user. Furthermore, above embodiments are described for use with a single user. However, alternate embodiments may be configured so that multiple remote control units for multiple users can transmit alerts to the same receiver. The invention has been described above by way of illustration, and the specific embodiments disclosed are not intended to limit the invention to the particular forms disclosed. The invention is thus to cover all modifications, equivalents, and alternatives falling within the spirit and scope of the following claims.

What is claimed is:

1. A wearable medical alert apparatus comprising:
a housing for containing the apparatus wearable by an individual;
a motion sensor contained within said housing, said motion sensor outputting a signal indicative of motion of said individual where an absence of signal indicates a potential need for medical assistance for said individual;
low power circuitry, contained in said housing, for processing said signal to determine said absence of signal, said circuitry outputting a first signal after a first period of time when said absence of signal has been detected for a duration of said first period of time, said circuitry outputting a second signal after a second period of time, said second period of time being substantially longer than said first period of time, when said absence of signal has been detected for a duration of said second period of time; and
a transmitter, contained in said housing, responsive to said first and second signal for transmitting an alert signal indicating need for said medical assistance when said first signal and said second signal is output by said circuitry and said alert signal is repeated at intervals of said first period of time.

2. The apparatus as recited in claim 1, further comprising a first switch, contained in said housing, operable to cancel transmission of said alert signal when activated.

3. The apparatus as recited in claim 2, further comprising a second switch, contained in said housing, operable to enable said transmitter to transmit said alert signal when activated.

4. The apparatus as recited in claim 1, wherein said motion sensor further outputs a large signal indicative that said individual has fallen and potentially needs medical assistance, said circuitry processes said signal to determine said large signal and outputs a third signal in response thereof and said transmitter responsive to said third signal for outputting said alert signal.

5. The apparatus as recited in claim 1, further comprising means for adjusting a threshold for detection of said absence of signal.

6. The apparatus as recited in claim 1, further comprising means for adjusting said duration of said second period of time.

7. The apparatus as recited in claim 1, wherein said circuitry comprises discrete analog and logic components to minimize the power requirements.

8. The apparatus as recited in claim 1, wherein said transmitter is configured for short-range transmission to a dedicated receiver.

9. A wearable medical alert apparatus comprising:
means for containing the apparatus wearable by an individual;
means for outputting a signal indicative of motion of said individual where an absence of signal indicates a potential need for medical assistance for said individual;
means for processing said signal to determine said absence of signal and outputting a trigger signal indicating that said absence of signal has been detected for a duration; and
means for transmitting an alert signal in response to said trigger signal.

10. The apparatus as recited in claim 9, further comprising means for canceling transmission of said alert signal.

11. The apparatus as recited in claim 10, further comprising means for manually triggering said transmitter to transmit said alert signal.

12. The apparatus as recited in claim 9, further comprising means for detecting a large signal indicative that said individual has fallen and potentially needs medical assistance and triggering said transmitter to output said alert signal.

13. The apparatus as recited in claim 9, further comprising means for adjusting a threshold for detection of said absence of signal.

14. The apparatus as recited in claim 9, further comprising means for adjusting said duration.

15. A medical alert system comprising:
a remote control unit comprising:
a housing for containing said unit wearable by an individual;
a motion sensor contained within said housing, said motion sensor outputting a signal indicative of motion of said individual where an absence of signal indicates a potential need for medical assistance for said individual;
low power circuitry, contained in said housing, for processing said signal to determine said absence of signal, said circuitry outputting a first signal after a first period of time when said absence of signal has been detected for a duration of said first period of time, said circuitry outputting a second signal after a second period of time, said second period of time being substantially longer than said first period of time, when said absence of signal has been detected for a duration of said second period of time;
a transmitter, contained in said housing, responsive to said first and second signal for transmitting an alert signal indicating need for said medical assistance when said first signal and said second signal is output by said circuitry and said alert signal is repeated at intervals of said first period of time; and
a first switch, contained in said housing, operable to cancel transmission of said alert signal when activated; and
an alert signal receiver module comprising:
a receiver configured to receive said transmitted alert signal; and
an alert module for notifying proper authorities of a medical or situation.

16. The system as recited in claim 15, further comprising a second switch, contained in said housing, operable to enable said transmitter to transmit said alert signal when activated.

17. The system as recited in claim 15, wherein said motion sensor further outputs a large signal indicative that said individual has fallen and potentially needs medical assistance, said circuitry processes said signal to determine said large signal and outputs a third signal in response thereof and said transmitter responsive to said third signal outputs said alert signal.

18. The system as recited in claim 15, further comprising means for adjusting a threshold for detection of said absence of signal.

19. The system as recited in claim 15, further comprising means for adjusting said duration of said second period of time.

20. The system as recited in claim 15, wherein said circuitry comprises discrete analog and logic components to minimize the power requirements.
